(19) United States
(12) Patent Application Publication
(10) Pub. No.: US 2021/0301978 A1
(43) Pub. Date: Sep. 30, 2021

(54) SELF-BRACING WATERTIGHT TANK WALL

(71) Applicant: Gaztransport Et Technigaz, Saint Remy Les Chevreuse (FR)

(72) Inventors: Mohamed Sassi, Saint Remy Les Chevreuse (FR); Pierre Jean, Saint Remy Les Chevreuse (FR)

(21) Appl. No.: 17/261,555

(22) PCT Filed: Jul. 26, 2019
(86) PCT No.: PCT/FR2019/051857

§ 371 Date: Jan. 19, 2021

(30) Foreign Application Priority Data
Jul. 26, 2018 (FR) 1856994

(51) Int. Cl. F17C 3/02; F17C 9/00; F17C 13/08

(52) U.S. Cl. CPC F17C 3/025; F17C 2223/0161; F17C 13/082; F17C 2203/013; F17C 2203/0333; F17C 2270/0105; F17C 2205/0355; F17C 2209/232; F17C 2201/0152; F17C 2203/035; F17C 2203/0358; F17C 2203/0619; F17C 2203/0643; F17C 2203/0646; F17C 2203/0651; F17C 2205/0379; F17C 2209/221; F17C 2221/012; F17C 2221/033; F17C 2221/035; F17C 9/00

(57) ABSTRACT

The invention relates to a sealed tank wall used to form a sealed tank for storing a fluid, the wall comprising:
a flat frame (3) including a perimeter (4) and longitudinal stiffening members (5) arranged inside the perimeter (4) in a longitudinal direction such that each longitudinal stiffening member extends from one side of the perimeter (4) to an opposite side of the perimeter (4), the perimeter (4) and the longitudinal stiffening members (5) being designed to form openings in the frame (3),
lobed walls fastened to the frame (3) by welding about said openings to close said openings, such as to project into a thickness direction orthogonal to the frame (3) and towards the outside of the tank to be formed.

### TECHNICAL DOMAIN

The invention pertains to the field of sealed tank walls for storing or transporting fluids, as well as to the field of sealed and thermally insulating tanks for low-temperature liquefied gases such as liquefied petroleum gas (LPG), liquefied natural gas (LNG) and liquid hydrogen.

### TECHNOLOGICAL BACKGROUND

Prismatic sealed tanks are for example known from patent EP0166492. Such tanks comprise an outer structure including a plurality of flat walls assembled together to form a prismatic structure, and notably a rectangular parallelepipedic structure.

To do so, a plurality of flat walls are assembled together using scaffolding to form the prismatic structure.

In order to make such tanks self-supporting i.e. able to withstand the pressure of a fluid contained in the tank without external assistance, the tank includes a system of internal stiffening members designed to reinforce the walls of the outer structure. In this case, the internal stiffening members are bars linking one wall to an opposite wall such as to prevent the deformation of the walls of the tank caused by the pressure of the fluid exerted from the inside to the outside of the tank.

The internal stiffening members are arranged in the tank to form a lattice structure. Such tanks include a plurality of bars arranged in different directions such as to absorb the forces caused by the pressure of the fluid exerted in multiple directions.

However, a tank with such a system of internal stiffening members fastened to flat walls is not suitable for transporting cryogenic fluids such as liquefied natural gas. Indeed, cryogenic containers exert significant stresses on tanks, notably on account of the extremely low temperature thereof, which causes a thermal contraction of the component parts of the tanks, as well as on account of the increase in the gas phase thereof over time, which generates a significant pressure on the walls of the tanks.

### SUMMARY

One idea at the heart of the invention is to facilitate the assembly of the tank walls while increasing the strength of the wall against the pressure of a fluid.

Another idea at the heart of the invention is to improve the strength of a self-supporting tank against high stresses caused for example by the pressure of the fluid contained in the tank and any thermal contraction present.

Another idea at the heart of the invention is to optimize the compactness of the self-supporting tank, i.e. to optimize the ratio between the usable volume of the container of the tank and the total volume occupied by the tank.

According to one embodiment, the invention provides a sealed tank wall used to form a sealed tank for storing a fluid, the wall comprising:
a flat frame including a perimeter and longitudinal stiffening members arranged inside the perimeter in a longitudinal direction such that each longitudinal stiffening member extends from one side of the perimeter to an opposite side of the perimeter, the perimeter and the longitudinal stiffening members being designed to form openings in the frame,
lobed walls fastened to the frame by welding about said openings to close said openings, such as to project into a thickness direction orthogonal to the flat frame and towards the outside of the tank to be formed.

Flat frame means a frame with no curvature in a thickness direction.

These features enable the tank wall to be made of simple elements. Indeed, the frame forms a cheap structure for fastening the lobed walls and supporting the tank wall using longitudinal stiffening members. The flat shape thereof enables the tank wall to be assembled flat. This obviates the need to use scaffolding to assemble the wall. Furthermore, welding robots can notably be used to fasten the lobed walls to the frame on account of the flat shape thereof, thereby simplifying and speeding up assembly.

The lobed walls of the tank therefore help to improve the mechanical strength of the outer structure. Indeed, the lobed walls enable the forces present during pressurization of the tank to be redirected towards the longitudinal stiffening members and the perimeter of the frames, thereby preventing the frames from being subjected to excessive forces. This helps to limit the thickness of the lobed walls, which are subjected to lesser forces than an equivalent flat wall.

Finally, the outward-curving lobed walls of the tank help to optimize the capacity of the tank by significantly increasing usable volume compared to a tank with flat walls.

According to the embodiments, such a tank wall may have one or more of the following features.

According to one embodiment, the perimeter has a rectangular shape and comprises a plurality of bars assembled together.

According to one embodiment, the frame has complementary stiffening members, the complementary stiffening members having a first end fastened to one side of the perimeter and a second end fastened to an opposite side of the perimeter and complementary stiffening members extending in a transverse direction perpendicular to the longitudinal direction of the longitudinal stiffening members.

According to one embodiment, the wall has a thermally insulating barrier fastened to the frame on the outside of the tank to be formed.

According to one embodiment, the thermally insulating barrier has an inner surface shaped to match the lobed walls.

According to one embodiment, the thermally insulating barrier has an inner layer made of a flexible deformable insulating material and an outer layer made of a rigid insulating material.

According to one embodiment, the lobed walls have curved plates with at least two curved sides, and closing plates positioned on the curved sides of the curved plates, the closing plates sealingly linking the curved sides to the frame.

According to one embodiment, the curved plates are rectangular curved plates with two curved sides and two straight sides, the straight sides being welded to the frame on either side of an opening.

According to one embodiment, the frame is formed between an outer envelope, preferably flat, and an inner envelope, preferably flat, in the thickness direction.

According to one embodiment, the lobed walls project from the outer envelope of the frame in which said walls are fastened.

According to one embodiment, the lobed walls are positioned between the outer envelope and the inner envelope of the frame in which said walls are fastened.

According to one embodiment, the two curved sides are welded sealingly to the frame on either side of an opening.

According to one embodiment, the invention provides a sealed tank wall for storing a fluid, the tank comprising:
an outer structure comprising a plurality of tank walls assembled together to form a prismatic structure delimiting an internal space, at least two of the tank walls being as described above,
internal stiffening members positioned in the internal space of the outer structure to form a lattice structure, each internal stiffening member having a first end fastened to the frame of a first of the at least two tank walls and a second end fastened to the frame of a second of the at least two tank walls opposite the first tank wall, the internal stiffening members being fastened to said frames to absorb a force caused by the pressure in said internal space.

According to one embodiment, one, some, several or all of the internal stiffening members are positioned level with a longitudinal stiffening member of said frame. According to one embodiment, one, some, several or all of the internal stiffening members extend perpendicular to one of said tank walls. According to one embodiment, some, several or all of the internal stiffening members are positioned level with the longitudinal stiffening members of said frames and extend perpendicular to some, several or all of the tank walls.

According to one embodiment, the two opposing walls are parallel and one or several of said internal stiffening members extend substantially straight and perpendicular to the two tank walls.

According to one embodiment, each of the tank walls is as described above.

According to the embodiments, such a tank may have one or more of the following features.

According to one embodiment, the frame is made of square tubes fastened to one another, for example by welding.

This makes the frame simple and cheap to manufacture since the frame is made up exclusively of elements that are easy to assemble together.

According to one embodiment, the tank has lobed walls fastened to the frames by welding about each opening to sealingly close said openings.

According to one embodiment, the internal stiffening members are fastened to the longitudinal stiffening members.

According to one embodiment, the internal stiffening members are distributed regularly over each of the longitudinal stiffening members.

According to one embodiment, the frame, the lobed walls and/or the internal stiffening members are made of metal, such as stainless steel, aluminum, Inver®, i.e. an alloy of iron and nickel with a coefficient of expansion typically between 1.2×10−6 and 2×10−6 K−1, or of an iron alloy with a high manganese content with a coefficient of expansion of around 7×10−6 K−1.

According to one embodiment, the lobed walls have curved plates with at least two curved sides, and closing plates positioned on the curved sides of the curved plates, the closing plates sealingly linking the curved sides to one of the frames.

According to one embodiment, the curved plates are rectangular curved plates with two curved sides and two straight sides, the straight sides being welded to one of the frames of the outer structure, on either side of an opening.

According to one embodiment, one, some, several or all of the closing plates are elongate flat plates.

According to one embodiment, one, some, several or all of the closing plates have at least one surface and at least one edge, the surface being fastened to the curved side of at least one curved plate and the edge being fastened to the frame.

According to one embodiment, one, some, several or all of the closing plates are plates forming a portion of an ellipsoid of revolution.

According to one embodiment, one, some, several or all of the closing plates have two edges, one edge being fastened to the curved plate and the other edge being fastened to the frame.

According to one embodiment, the internal stiffening members include first stiffening members oriented in a first direction, second stiffening members oriented in a second direction different from the first direction, and third stiffening members oriented in a third direction different from the first direction and from the second direction.

According to one embodiment, the first direction, the second direction and the third direction form a three-dimensional orthogonal frame.

These features enable the internal stiffening members to form a three-dimensional lattice enabling the outer structure to withstand the stresses applied to the tank in all directions.

(claim 14) According to one embodiment, the internal stiffening members are made of bars of square section.

According to one embodiment, one, some, several or all of the first stiffening members have at least one orifice that is designed to enable one of the third stiffening members to pass through the first stiffening member.

By virtue of these features, the orifice enables a first stiffening member in the first direction to cross a third stiffening member in the third direction, which helps to reinforce the stiffening members at these crossings, for example by preventing said stiffening members from buckling.

According to one embodiment, one, some, several or all of the second stiffening members have at least one orifice that is designed to enable one of the third stiffening members to pass through the second stiffening member.

By virtue of these features, the orifice enables a second stiffening member in the second direction to cross a third stiffening member in the third direction, which helps to reinforce the stiffening members at these crossings, for example by preventing said stiffening members from buckling.

According to one embodiment, each internal stiffening member has at least one elongate sheet and at least one profile including a base fastened to the elongate sheet and two flanges on either side of the base, the flanges projecting from the elongate sheet.

The profile thus helps to increase the rigidity of the internal stiffening member, notably in flexion.

According to one embodiment, one, some, several or all of the frames have complementary stiffening members, the complementary stiffening members having a first end fastened to one side of the perimeter and a second end fastened to an opposite side of the perimeter and complementary stiffening members extending in a direction perpendicular to the longitudinal direction of the longitudinal stiffening members.

These features help to reinforce the frame in the direction perpendicular to the direction of the longitudinal stiffening members.

According to one embodiment, one, some, several or all of the first stiffening members and/or one, some, several or all of the second stiffening members have two elongate sheets and a plurality of profiles positioned between the two elongate sheets, the profiles including a base fastened to one of the elongate sheets and two flanges on either side of the base, the flanges projecting from each elongate sheet, and in which the profiles are spaced apart regularly on the elongate sheet.

According to one embodiment, the orifice that is designed to enable one of the third stiffening members to pass through one of the first stiffening members or one of the second stiffening members is a space formed between the profiles.

The first stiffening members and the second stiffening members are therefore designed to increase in stiffness and to augment the stiffening role of the outer structure. Furthermore, the profiles are spaced apart such as to enable the crossings of the lattice of stiffening members.

According to one embodiment, one, some, several or all of the complementary stiffening members have two elongate sheets and a plurality of profiles positioned between the two elongate sheets, the profiles including a base fastened to one of the elongate sheets and two flanges on either side of the base, the flanges projecting from each elongate sheet, and in which the profiles are spaced apart regularly on the sheet such as to form spaces designed to enable crossing with the longitudinal stiffening members of a frame.

According to one embodiment, one, some, several or all of the internal stiffening members and/or one, some, several or all of the longitudinal stiffening members and/or one, some, several or all of the complementary stiffening members have fishplates at the ends thereof.

The fishplates thus help to reduce the stresses applied to the stiffening members at the join with the longitudinal stiffening members or the perimeter of the frame.

According to one embodiment, the fishplates are triangular fishplates or circular-arc fishplates.

According to one embodiment, one, some, several or all of the third stiffening members have two elongate sheets and one or more profiles positioned between the two elongate sheets, the profile or profiles including a base fastened to one of the elongate sheets and two flanges on either side of the base, the flanges projecting from each sheet.

According to one embodiment, one, some, several or all of the third stiffening members have a single profile extending over some or all of the length of the third stiffening member.

According to one embodiment, one, some, several or all of the third stiffening members have several profiles arranged continuously or spaced apart over the length thereof.

According to one embodiment, the section of the third stiffening member is less than the section of the orifice.

According to one embodiment, the distance between two sheets of the third stiffening member is less than the distance between two sheets of the first stiffening member and/or second stiffening member.

According to one embodiment, the width of the sheets of the third stiffening member at the crossings with a first stiffening member or a second stiffening member is less than the distance between two profiles of the first stiffening member or of the second stiffening member.

The dimensions of the third stiffening members therefore enable said stiffening members to be inserted into one of the first stiffening members or the second stiffening members to form the crossing between the stiffening members.

According to one embodiment, the sealed tank has a thermally insulating barrier fastened to the outside of the outer structure on each of the frames.

According to one embodiment, the thermally insulating barrier has an inner surface shaped to match the lobed walls.

According to one embodiment, the inner surface is precut to fit the curved shape of the lobed walls.

According to one embodiment, the thermally insulating barrier has one or more layers of one or more materials, for example fibrous materials such as glass wool, mineral wool, polymer foam, notably polyurethane foam, expanded polystyrene, or polyethylene foam.

According to one embodiment, the thermally insulating barrier has an inner layer made of a flexible deformable insulating material such as glass wool.

The first layer of the thermally insulating barrier can therefore be compressed against the lobed wall to fit the shape.

According to one embodiment, the thermally insulating barrier has an outer layer made of a rigid insulating material such as polyurethane foam or expanded polystyrene.

According to one embodiment, the thermally insulating barrier is made up of a plurality of insulating panels arranged beside one another.

According to one embodiment, the insulating panels that are positioned away from the edges of the prismatic structure of the tank are rectangular parallelepipedic panels.

According to one embodiment, the insulating panels that are positioned on the edges of the prismatic structure of the tank are cylindrical panels with a triangular base.

According to one embodiment, each third stiffening member comprises a single elongate stiffening member extending from one tank wall to an opposite tank wall.

According to one embodiment, each first stiffening member and/or each second stiffening member has a plurality of first bars and/or second bars respectively, the first bars or the second bars being aligned with one another in the first direction or the second direction respectively, the first bars or the second bars being spaced apart from one another.

According to one embodiment, some or each of the third stiffening members has a plurality of third bars, the third bars being aligned with one another in the third direction and being spaced apart from one another.

According to one embodiment, some or each of the complementary stiffening members has a plurality of complementary bars, the complementary bars being aligned with one another and being spaced apart from one another.

According to one embodiment, some or each of the complementary stiffening members has a plurality of complementary bars, the complementary bars being aligned with one another and being spaced apart from one another.

According to one embodiment, the first bars include two first end bars positioned at the ends of the first stiffening member and at least one first intermediate bar positioned between the first end bars, two adjacent first bars being fastened to one another by means of one of the third stiffening members.

According to one embodiment, the second bars include two second end bars positioned at the ends of the second stiffening member and at least one second intermediate bar positioned between the second end bars, two adjacent second bars being fastened to one another by means of one of the third stiffening members.

According to one embodiment, the third bars include two third end bars positioned at the ends of the third stiffening member and at least one third intermediate bar positioned between the third end bars.

According to one embodiment, the first end bars or the second end bars have a first end fastened to the outer structure and a second end fastened to one of the third stiffening members.

According to one embodiment, the first intermediate bars or the second intermediate bars have a first end fastened to one of the third stiffening members and a second end fastened to another of the third stiffening members.

According to one embodiment, the lattice structure has stiffening-member nodes, each stiffening-member node being designed to form an intersection zone in the lattice structure where at least two internal stiffening members cross.

Internal stiffening member means a stiffening member formed by one of the first stiffening members, one of the second stiffening members, one of the third stiffening members, one of the reinforcing stiffening members or, where applicable, one of the complimentary stiffening members.

According to one embodiment, each stiffening-member node is designed to form an intersection zone in the lattice structure where two first bars and two second bars are fastened to a given third stiffening member.

According to one embodiment, the tank has connectors formed by at least one connection plate, and two first adjacent bars or two second adjacent bars or two third adjacent bars are fastened to one another by means of one of the connectors.

According to one embodiment, said connectors are dual connectors formed by a first connection plate and a second connection plate orthogonal to the first connection plate, the first connection plate having a fitting orifice, the second connection plate passing through the first connection plate via the fitting orifice.

According to one embodiment, two adjacent first bars and two adjacent second bars are welded to the first connection plate of one of the dual connectors, and two adjacent third bars are welded to the second connection plate of said dual connector.

According to one embodiment, the tank has single connectors formed by a single connection plate, the connection plate being fastened to one of the frames of the tank, for example to one of the longitudinal stiffening members or to the perimeter of the frame.

According to one embodiment, the complementary bars are welded at each end thereof to the connection plate of one of the single connectors.

According to one embodiment, the first end bars, the second end bars and the third end bars are welded at one end thereof to one of the single connectors and at the other end thereof to one of the dual connectors.

According to one embodiment, the first intermediate bars, the second intermediate bars and the third intermediate bars are welded at each of the ends thereof to one of the dual connectors.

According to one embodiment, an internal stiffening member is for example fastened to another internal stiffening member by welding.

According to one embodiment, the internal stiffening members are fastened to one of the connectors by welding.

According to one embodiment, the internal stiffening members and the connectors are designed to be assembled together with at least two degrees of freedom, preferably two degrees of freedom in translation, and more preferably exactly two degrees of freedom in translation.

According to one embodiment, the at least one connection plate is flat.

According to one embodiment, the two degrees of freedom in translation are in the plane of the connection plate.

According to one embodiment, the internal stiffening members and the connectors are designed to be assembled together before the internal stiffening member is welded to the connector.

According to one embodiment, the at least one connection plate has a flat peripheral edge, the internal stiffening member being welded to the connector on the flat peripheral edge of the connection plate.

According to one embodiment, the bars of the internal stiffening members and/or of the complementary stiffening members and/or of the reinforcing stiffening members have a pair of parallel fastening slots at each end thereof, and the bars of the internal stiffening members and/or of the complementary stiffening members and/or of the reinforcing stiffening members are designed to be welded to one of the connection plates by inserting said connection plate into the pair of fastening slots.

According to one embodiment, the internal stiffening members and/or the complementary stiffening members and/or the reinforcing stiffening members are made up of bars of circular section.

According to one embodiment, the fastening slots of a given pair of fastening slots are diametrically opposed.

According to one embodiment, the fastening slots of a given pair of fastening slots are positioned on two opposing edges of the end of the bar.

According to one embodiment, the bars of the internal stiffening members and/or of the complementary stiffening members and/or of the reinforcing stiffening members are designed to be welded to one of the connection plates by inserting said connection plate into the pair of fastening slots.

This enables the connection plate to be used as a flat welding support to facilitate the fastening of the bar to a connector. Furthermore, forming the slots in the bars instead of in the plates makes the device more adaptable and obviates the need for assembly and manufacturing tolerances.

According to one embodiment, the tank has reinforcing stiffening members inclined at an angle of approximately 45° in relation to the first direction, to the second direction or to the third direction, the reinforcing stiffening members being fastened at one of the ends thereof to a first stiffening-member node and at the other of the ends thereof to a second stiffening-member node or one of the tank walls.

According to one embodiment, the tank has reinforcing stiffening members fastened at the edges of the tank to the lattice structure, each reinforcing stiffening member being inclined at an angle of 45° in relation to the first direction, to the second direction or to the third direction.

According to one embodiment, the first stiffening members, the second stiffening members, the third stiffening members and the reinforcing stiffening members, and the complementary stiffening members where applicable, are fastened to one another to form a lattice structure.

According to one embodiment, a first of said tank walls is fastened to a second of said tank walls by welding the frame of the first tank wall to the frame of the second tank wall.

According to one embodiment, a first of said tank walls is fastened to a second of said tank walls by means of a lobed corner wall, the lobed corner wall having a first straight edge fastened to the perimeter of the first tank wall and a second straight edge fastened to the perimeter of the second tank wall.

According to one embodiment, the lobed corner walls project from the lattice structure towards the outside of the tank.

According to one embodiment, each lobed corner wall has a curved plate with two straight edges and at least two curved edges, preferably four curved edges.

According to one embodiment, the straight edges of the lobed corner walls are welded to the perimeters of two adjacent frames of the outer structure.

According to one embodiment, one of the lobed corner walls is welded via a curved edge to at least one other adjacent lobed corner wall, preferably to two other adjacent lobed corner walls.

According to one embodiment, one of the curved edges of a lobed corner wall extending in one of the first, second or third directions is welded to one of the curved edges of a lobed corner wall extending in another of the first, second or third directions.

According to one embodiment, the lobed corner walls are assembled with the frames of the outer structure such as to form a closed sealed surface.

According to one embodiment, the invention provides a sealed tank for storing a fluid, the tank comprising:
an outer structure comprising a plurality of tank walls assembled together to form a prismatic structure delimiting an internal space,
internal stiffening members positioned in the internal space of the outer structure such as to form a lattice structure, each internal stiffening member having a plurality of bars aligned with one another and spaced apart from one another,
connectors including at least one connection plate, at least two adjacent bars being welded to the connection plate, the connectors forming stiffening-member nodes where the internal stiffening members cross one another in different directions.

Such a tank may be part of an onshore storage facility, for example for storing LNG, or be installed on a coastal or deep-water floating structure, notably a liquefied natural gas carrier, a floating storage and regasification unit (FSRU), a floating production, storage and offloading (FPSO) unit, inter alia. Such a tank can also be used as a fuel tank in any type of ship.

According to one embodiment, the invention also provides a ship used to transport a cold liquid product that has a double hull and the aforementioned tank arranged in the double hull.

According to one embodiment, the sealed tank is fastened to the double hull using cables.

According to one embodiment, the sealed tank has a center and edges at the join between the frames, the cables being fastened at the edges of the tank and being fastened to the double hull such as to be oriented orthogonally to the direction linking the center of the tank to the edge where the cable is fastened.

Consequently, the cables are oriented such as to turn about the anchoring point thereof on the double hull during any thermal contraction of the tank, thereby preventing any compression/tensile stress on the cables that could cause the cables to break.

According to one embodiment, the invention also provides a manufacturing method for a prismatic sealed tank, in which the method includes the following steps:
providing several of the aforementioned tank walls,
assembling the tank walls together sealingly to form an open prismatic outer structure,
providing a plurality of internal stiffening members,
fastening the internal stiffening members to the inside of the outer structure such as to form a lattice structure, each internal stiffening member having a first end fastened to a frame and a second end fastened to an opposing frame, the internal stiffening members being fastened to the longitudinal stiffening members or to the perimeters of said frames,
assembling one or more tank walls to the open outer structure such as to sealingly close the prismatic outer structure.

The lattice structure formed by the stiffening members can therefore be used both to reinforce the tank and as scaffolding for assembly of the last walls used to close the outer structure.

According to one embodiment, the invention also provides a manufacturing method for a prismatic sealed tank, in which the method includes the following steps:
providing several of the aforementioned tank walls,
arranging one of the tank walls such as to form a bottom wall of the tank,
providing a plurality of internal stiffening members,
fastening the internal stiffening members to the bottom wall of the tank and to one another such as to form a lattice structure,
sealingly assembling the other tank walls to the bottom wall of the tank and to one another such as to form a closed prismatic outer structure, each internal stiffening member having a first end fastened to a frame and a second end fastened to an opposing frame, the internal stiffening members being fastened to the longitudinal stiffening members or to the perimeters of said frames.

The lattice structure formed by the stiffening members can therefore be used both to reinforce the tank and as scaffolding to assemble the walls together and to the bottom wall.

According to one embodiment, the invention also provides a method for loading onto or offloading from such a ship, in which a cold liquid product is channeled through insulated pipes to or from an onshore or floating storage facility to or from the tank on the ship.

According to one embodiment, the invention also provides a transfer system for a cold liquid product, the system including the aforementioned ship, insulated pipes arranged to connect the tank installed in the hull of the ship to an onshore or floating storage facility and a pump for driving a flow of cold liquid product through the insulated pipes to or from the onshore or floating storage facility to or from the tank on the ship.

### SHORT DESCRIPTION OF THE FIGURES

The invention can be better understood, and additional objectives, details, features and advantages thereof are set out more clearly, in the detailed description below of several specific embodiments of the invention given solely as non-limiting examples, with reference to the drawings attached.

FIG. 1 is a perspective view of a frame provided with complementary stiffening members for a self-supporting sealed tank.

FIG. 2 is a perspective view of an internal or complementary stiffening member for a self-supporting sealed tank according to a first variant.

FIG. 3 is a perspective view of an outer structure provided with internal stiffening members for a self-supporting sealed tank.

FIG. 4 is a detailed view of FIG. 3 showing only one crossing between two internal stiffening members.

FIG. 5 is a perspective view of a frame provided with lobed walls formed using curved plates and closing plates according to a first embodiment.

FIG. 6 is a perspective view of a self-supporting sealed tank including lobed walls according to a second embodiment.

FIG. 7 is a perspective view of a self-supporting sealed tank including an outer structure, stiffening members and a thermally insulating barrier.

FIG. 8 is a partial cross-section view of FIG. 7 showing one of the frames provided with lobed walls and the thermally insulating barrier.

FIG. 9 is a perspective view of a tank fastened to a double hull of a ship.

FIG. 10 is a cut-away schematic view of a ship including a sealed and thermally insulating fluid storage tank and of a loading/offloading terminal for this tank.

FIG. 11 is a perspective view of a lattice formed by the internal stiffening members according to a second variant.

FIG. 12 is a detailed view XII of FIG. 11, showing a plurality of assembled internal stiffening members.

FIG. 13 is a perspective view of a self-supporting sealed tank including lobed walls according to a third embodiment.

FIG. 14 is a cross-section view of one of the tank walls taken along the line XIV-XIV in FIG. 13.

FIG. 15 is a perspective view of a portion of a lattice formed by the internal stiffening members according to the second variant for a self-supporting sealed tank according to the third embodiment.

FIG. 16 is a perspective view of an outer structure for a self-supporting sealed tank according to another embodiment.

FIG. 17 is a cross-section view of a self-supporting sealed tank including a lattice comprising internal stiffening members according to a third variant.

FIG. 18 is a perspective view of an internal stiffening member according to the third variant.

FIG. 19 is a cross-section view taken along the line XIX-XIX in FIG. 17 showing the connection of the internal stiffening members to a dual connector.

### DETAILED DESCRIPTION OF THE EMBODIMENTS

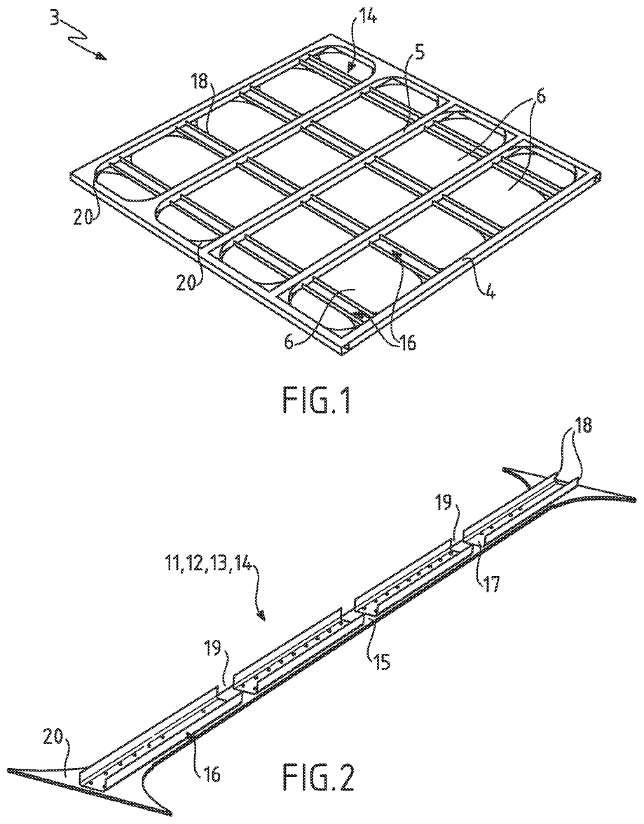

A self-supporting sealed tank 1 according to one embodiment that can be used to understand the invention is described below with reference to FIGS. 1 to 9 and 11 to 19.

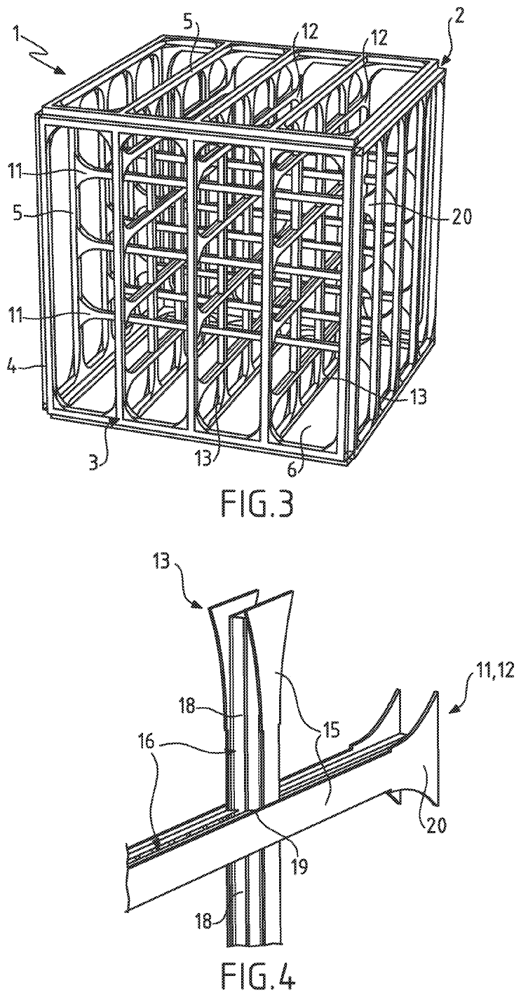

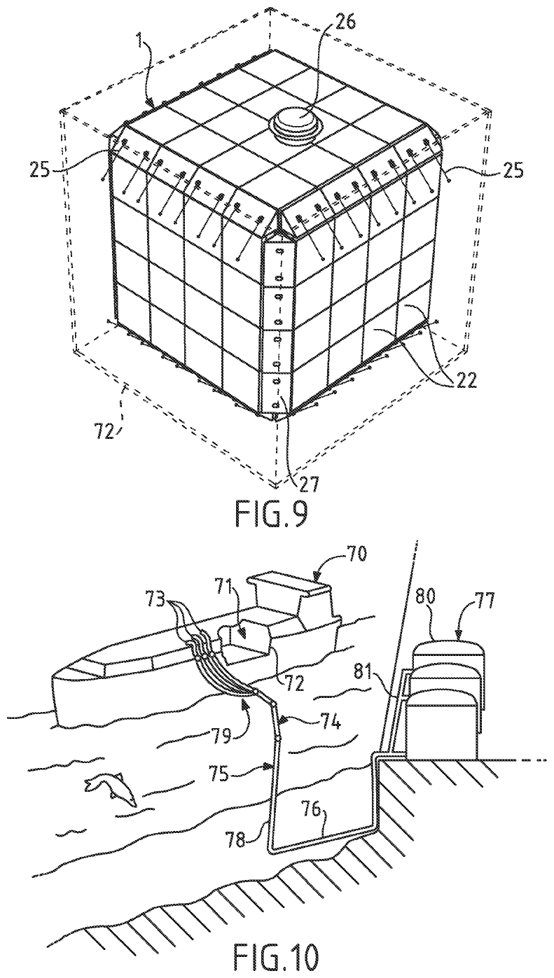

A self-supporting sealed tank 1 includes an outer structure 2 comprising a plurality of frames 3 assembled together such as to form a prismatic structure, for example as shown in the form of a rectangular parallelepiped in FIGS. 3 and 9.

FIG. 1 notably shows a frame 3 of the outer structure 2. The frame 3 comprises a perimeter 4 that is for example rectangular. The perimeter 4 is made using square tubes welded together at the ends thereof to form a rectangle. Furthermore, the apexes of the perimeter 4 are fitted with fishplates 20 to increase the mechanical strength of the perimeter 4. Longitudinal stiffening members 5 are placed inside the perimeter 4 such as to form openings 6 in the frame 3. Each longitudinal stiffening member 5 comprises a square tube with fishplates 20 fitted to the ends thereof. The longitudinal stiffening members 5 are welded to the perimeter 4 and distributed regularly over one side of the perimeter 4. One of the ends of a longitudinal stiffening member 5 is welded to one side of the perimeter 4 while the other end of the longitudinal stiffening member 5 is welded to the opposite side of the perimeter 4.

In order to reinforce the frame 3, complementary stiffening members 14 are welded to the perimeter 4 of the frame 3 in the direction perpendicular to the longitudinal direction of the longitudinal stiffening members 5. Each complementary stiffening member 14 has a first end welded to one side of the perimeter 4 and a second end welded to an opposite side of the perimeter 4.

The self-supporting sealed tank 1 also includes internal stiffening members 11, 12, 13 fastened inside the outer structure 2 such as to form a lattice structure, as shown in FIG. 3.

FIG. 2 shows an internal stiffening member 11, 12, 13 or a complementary stiffening member 14. The stiffening member 11, 12, 13, 14 comprises at least one elongate sheet 15 and a plurality of profiles 16 that are distributed regularly over the length of the elongate sheet 15. The profiles 16 have a base 17 fastened to a surface of the elongate sheet 15 and two flanges 18 on either side of the base 17. The flanges 18 are designed to project from the base 17 in the same direction to form a profile 16 with a U-shaped section.

The profiles 16 are spaced apart on the elongate sheet 15. These spaces between the profiles 16 form orifices 19 that notably enable the stiffening member 11, 12, 13, 14 to cross another element of the tank 1.

In the case of the complementary stiffening member 14, as shown in FIG. 1, the orifices 19 are designed to enable the longitudinal stiffening members 5 to cross each of the complementary stiffening members 14 such as to form a mesh reciprocally reinforcing the stiffening members 5, 14.

In the embodiment illustrated in FIGS. 3 and 4, the internal stiffening members 11, 12, 13 are doubled, i.e. there are two elongate sheets 15 each fitted with profiles 16. The flanges 18 of the profiles 16 of the first sheet 15 are oriented to project towards the second sheet 15 and reciprocally for the flanges 18 of the profiles 16 of the second sheet 15. The internal stiffening members 11, 12, 13 are also fitted with fishplates 20 at the ends thereof for fastening to the outer structure 2.

As shown in FIG. 3, the internal stiffening members 11, 12, 13 are welded to the longitudinal stiffening members 5 of the frames 3 at the ends thereof. Indeed, each internal stiffening member 11, 12, 13 is welded at one end thereof to a longitudinal stiffening member 5 of a first frame 3 and at the other end thereof to a longitudinal stiffening member 5 of a second frame 3 opposite the first frame 3. The internal stiffening members 11, 12, 13 include first stiffening members 11 oriented in a first direction, second stiffening members 12 oriented in a second direction orthogonal to the first direction, and third stiffening members 13 oriented in a third direction orthogonal to the first direction and orthogonal to the second direction. The first direction, the second direction and the third direction thus form a three-dimensional orthogonal frame.

Each first stiffening member 11 and each second stiffening member 12 are fastened to the outer structure 2 such as to cross a plurality of third stiffening members 13, as illustrated in FIGS. 3 and 4. Indeed, by virtue of the orifices 19 formed between the profiles 16 of the first stiffening members 11 and the second stiffening members 12, the third stiffening members 13 are inserted into a plurality of first stiffening members 11 and second stiffening members 12. To do so, the third stiffening members 13 are designed to have a smaller section than the first stiffening members 11 and the second stiffening members 12. Other words, the distance between the two elongate sheets 15 of each third stiffening member 13 is less than the distance between the two elongate sheets of each first stiffening member 11 and of each second stiffening member 12. Furthermore, the space between two profiles 16 of the first stiffening members 11 and of the second stiffening members 12 is greater than the width of the elongate sheets 15 of the first stiffening members 11 at the crossings of the stiffening members, as shown in FIG. 4.

FIG. 5 shows a frame 3 of the outer structure 2 provided with lobed walls 7, 10 according to a first embodiment. In this embodiment, the lobed walls 7, 10 are made up of curved plates 7 and closing plates 10. The curved plates 7 are rectangular and have two curved sides 8 and two straight sides 9. Each straight side 8 is welded sealingly, i.e. by means of a continuous weld seam along the entire length of the side, to a longitudinal stiffening member 5 or to the perimeter 4 depending on the positioning of the curved plate 7 on the frame 3. The curved sides 8 are welded sealingly to a closing plate 10, the closing plate 10 being in turn welded sealingly to the perimeter 4. Thus, the frame 3 provided with lobed walls 7, 10 forms a sealed surface. The closing plates 10 in this embodiment are flat elongate plates including a first flat surface, second flat surface and a plurality of edges. Each closing plate 10 fastened to the curved side 8 of one or more curved plate via one of the flat surfaces thereof. Each closing plate 10 is fastened to the frame 3 by one of the edges thereof. Thus, the assembly comprising the curved plate 7, the closing plates 10 and the frame 3 forms a sealed closed surface.

In the embodiment shown in FIG. 5, the closing plate 10 is used to be welded to a plurality of curved plate 7. Indeed, in the example shown, a closing plate 10 enables the curved sides 8 of several curved plates 7 to be fastened to the frame 3, which helps to limit the number of parts that require fastening. In a variant not shown, a different closing plate 10 can be used for each of the curved plates 7.

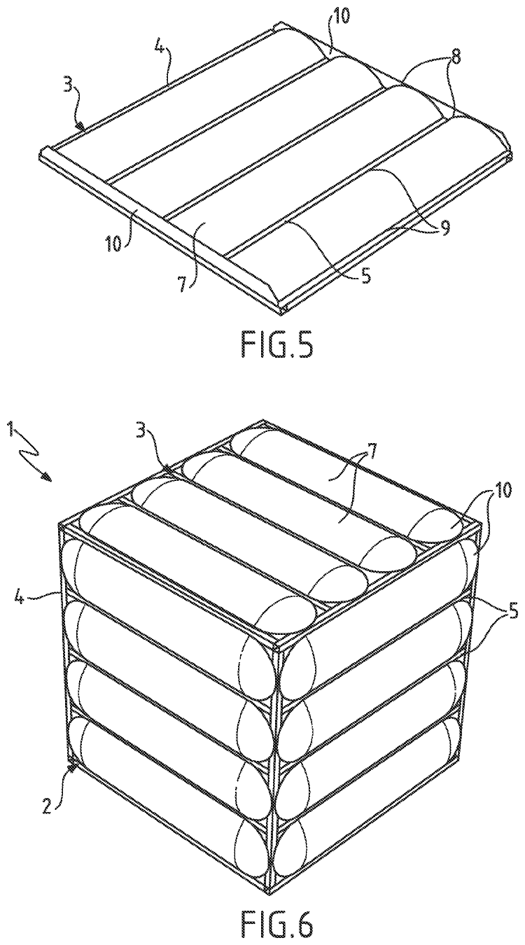

FIG. 6 shows a second embodiment of the lobed walls 7, 10 mounted on a self-supporting sealed tank. In this embodiment, the closing plate 10 is a portion of an ellipsoid of revolution, for example a quarter-ellipsoid, as shown. The closing plate 10 thus extends the curved plate 7, in the manner of a hull, such as to turn the curved side 8 of the curved plate 7 towards the frame 3. Indeed, one of the edges formed by the closing plate 10 is welded to the curved side of the curved plate 7, while the other edge formed by the closing plate 10 is welded to the frame 3. Thus, the assembly comprising the curved plate 7, the closing plates 10 and the frame 3 forms a sealed closed surface. In the embodiment shown in this figure, the fishplates 20 of the frame 3 formed on the perimeter 4 and the longitudinal stiffening members help to close the sealed surface. Indeed, the edge of the closing plate 10 welded to the frame 3 is welded both to the longitudinal stiffening members and/or to the perimeter 4, but also to the fishplates 20 adjacent thereto.

In another embodiment not shown, the lobed walls 7, 10 are for example made by stamping such that the lobed walls are elongate domes welded both to the longitudinal stiffening members 5 and to the perimeter 4 defining the opening 6 into which the lobed wall is placed. Consequently in this embodiment, the lobed wall is made up of a single element and does not need to include a curved plate 7 and a closing plate 10 since the elongate dome is fastened about the entire circumference thereof to the frame 3.

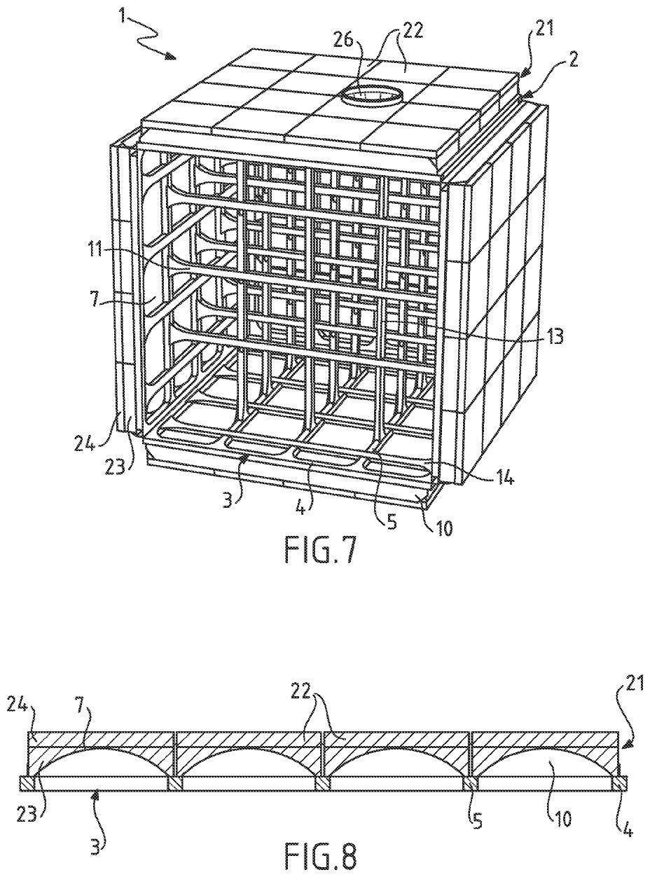

FIG. 7 shows a self-supporting sealed tank 1 during assembly, before said tank is fitted with the second stiffening members 12 and one of the frames 3 forming the outer structure 2. As can be seen in FIGS. 7 and 8, the sealed tank 1 is also made of a thermally insulating barrier 21. The thermally insulating barrier 21 includes a plurality of insulating panels 22 distributed over the entire outer structure 2 such as to form a continuous thermally insulating barrier 21 over the entire tank to obtain a sealed and thermally insulating tank 1 for example for use with cryogenic fluids.

The insulating panels 22 comprise two layers 23, 24, an inner layer 23 in this case made of glass wool, and an outer layer 24 in this case made of low-density polyurethane foam. The inner layer 23 is precut to fit the curved shape of the curved plates 7. Since the material used to make the inner layer 23 is easily compressible, the cut need not be curved, but can be made along two inclined planes. Indeed, when fastening the insulating panels 22 to the outer structure 2, the inner layer 23 is compressed on the curved plate 7 to fit the shape of the curved plate 7, as shown in FIG. 8.

Thus, each tank wall comprises a frame 3 provided with a perimeter 4 and longitudinal stiffening members 5, complementary stiffening members 14 fastened to the frame 3, lobed walls 7, 10 fastened to the frame 3 and insulating panels 22 forming the thermally insulating barrier 21.

In order to assemble such a sealed and thermally insulating self-supporting tank 1, the different tank walls are first assembled. Indeed, the design of the tank walls makes it possible to work flat without the need for scaffolding. The frame 3 is therefore first assembled using square tubes in order to form the perimeter 4 and the longitudinal stiffening members 5. The complementary stiffening members 14 are then welded to the perimeter 4, overlapping the longitudinal stiffening members 5.

The curved plates 7 are then placed in the openings 6 formed in the frame 3 and welded to the frame 3 via the straight sides thereof. This enables a welding robot to be used to fasten the curved plates 7, thereby reducing assembly time. Closing plates 10 are then welded both to the curved sides of the curved plates and to the perimeter 4 such as to close the space left open between the curved side and the perimeter 4 in order to obtain a sealed tank wall. Finally, insulating panels 22 are placed on the lobed walls 7, 10 and fastened to the frame 3 such as to form a thermally insulating barrier 21 for each tank wall. Thus, each of the tank walls is assembled separately and simply. Furthermore, the flatness of the frame enables each wall to be assembled flat before assembling the walls together, thereby obviating the need for scaffolding.

Once all of the tank walls have been assembled, the tank walls are assembled together by welding the adjacent edges of each frame 3 to one another. Only one tank wall is not assembled, as shown in FIG. 7, enabling the first stiffening members 11 and the third stiffening members 13 to be fastened to the inside of the tank on the different longitudinal stiffening members 5. The tank top wall is fitted with a liquid dome 26 notably enabling access for the different equipment used to fill and empty the tank 1, but also to finish the assembly of the tank 1 when the last tank wall is assembled with the others. The last tank wall is then assembled with the other tank walls and the second stiffening members 12 are welded to said wall and the opposite wall.

FIG. 9 shows a sealed and thermally insulating self-supporting tank 1 fastened to a double hull 72 of a ship 70. As shown in this figure, the tank 1 is fitted with edge insulating panels 27 at the edges thereof to enable the joint between the insulating panels 22 of a first wall and the insulating panels 23 of a second wall orthogonal to the first wall. In the embodiment shown, the edge insulating panels 27 are therefore cylindrical with a triangular base.

In order to fasten the tank 1 to the double hull 72, cables 25 are used to link the edges of the tank top wall to the double hull 72, as well as the edges of the tank bottom wall to the double hull 72. The cables therefore have one end fastened to the double hull 72 and another end fastened at the perimeter 4 of the lower and upper frames.

The cables 25 are fastened such as to be oriented orthogonally to a direction linking the edge of the tank 1 where the cable 25 is fastened and the opposite edge of the tank 1. Consequently, during thermal contraction of the tank 1, the cables 25 are oriented such as to turn about the anchoring point thereof on the double hull 72, thereby preventing any compression/tensile stress on the cables that could cause the cables to break. The tank 1 is thus fastened to the double hull 72 in a robust manner in consideration of the possibility of thermal contraction caused by a cargo of cryogenic fluid, for example.

FIGS. 11 and 12 show a lattice structure of a self-supporting sealed tank formed by internal stiffening members according to a second variant, the outer structure 2 not being shown in order to improve visibility. This variant differs from the first variant, illustrated notably in FIG. 3, in the shape of the internal stiffening members, as well as in the arrangement of the internal stiffening members in relation to one another.

The lattice structure in FIGS. 11 and 12 includes, as before, first stiffening members 11 extending in the first direction, second stiffening members 12 extending in the second direction, and third stiffening members 13 extending in the third direction. However, in this variant, the stiffening members 11, 12, 13 are made of bars of square section.

Furthermore, the third stiffening members 13 are made from a single elongate bar extending from one tank wall to an opposite tank wall. Each first stiffening member 11 is formed by two first end bars 111 positioned at the ends of the first stiffening member 11, and a plurality of first intermediate bars 112 positioned between the first end bars 111. The first bars of a given first stiffening member 11 are aligned and spaced apart from one another in the first direction.

Similarly, each second stiffening member 12 is formed by two second end bars 121 positioned at the ends of the second stiffening member 12, and a plurality of second intermediate bars 122 positioned between the second end bars 121. The second bars of a given second stiffening member 12 are aligned and spaced apart from one another in the second direction.

In order to form the lattice structure and to solidify all of the internal stiffening members in relation to one another, the first stiffening members 11 and the second stiffening members 12 are fastened to the third stiffening members 13 at stiffening-member nodes 28, thereby forming an intersection between a first stiffening member 11, a second stiffening member 12 and a third stiffening member 13. Thus, at a stiffening-member node 28 as shown in greater detail in FIG. 12, two first bars 111, 112 and second bars 121, 122 are fastened on each of the sides of a third stiffening member 13. The space between two adjacent first bars 111, 112 or between two adjacent second bars 121, 122 is thus filled by a third stiffening member 13.

The first end bars 111 and the second end bars 121 have a first end fastened to the outer structure 2 and a second end fastened to one of the third stiffening members 13. The first end of the first end bars 111 and of the second end bars 121 is fitted with a fishplate 20 formed by two triangular flanges fastened on either side of the end bars 111, 121.

The lattice structure in FIGS. 11 and 12 also includes reinforcing stiffening members 29 positioned at the edges of the outer structure 2. Indeed, the reinforcing stiffening members 29 are fastened on one side to an edge of the outer structure 2 and on the other side to one of the stiffening-member nodes adjacent to said edge of the outer structure 2, such that the reinforcing stiffening member is inclined at an angle of 45° in relation to the first direction, to the second direction or to the third direction, depending on the orientation of the edge.

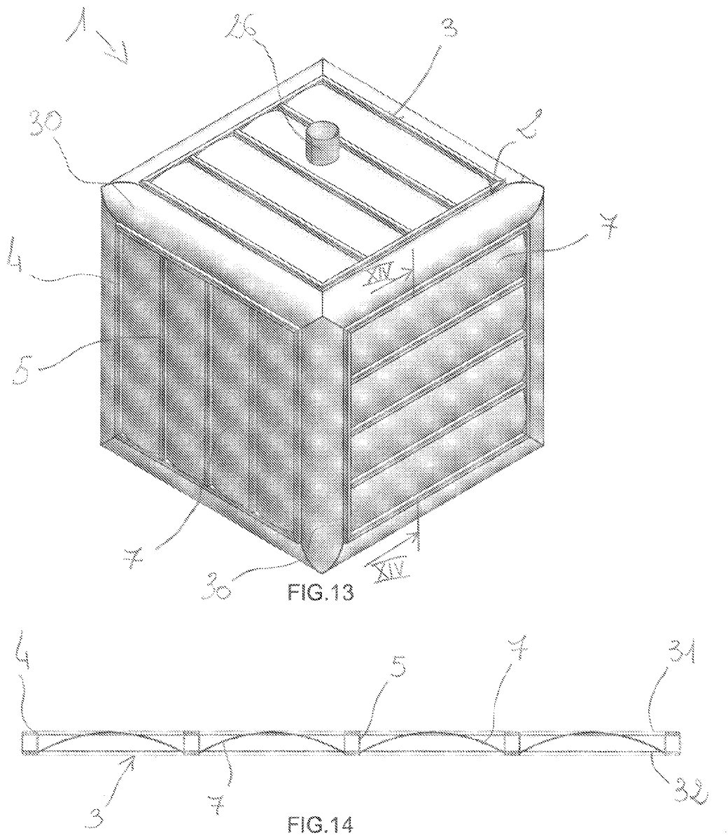

FIG. 13 shows a self-supporting sealed tank including lobed walls according to a third embodiment. In the preceding embodiments, the curved plates 7 of the lobed walls project outwards from the tank such as to also project outside the frame 3 in the thickness direction over which the curved plates 7 are fastened. Unlike in these embodiments, the third embodiment shows lobed walls that are included in the thickness of the frame 3 in which said lobed walls are fastened, which enables the tank wall to be flat despite the lobed walls. Therefore, as illustrated in the cross-section view in FIG. 14, the curved plates 7 of the lobed walls still project towards the outside of the tank, but in this case the four edges of the curved plate are welded to the frame 3. Since the frame 3 is formed between a flat outer envelope 31 and a flat inner envelope 32 in the thickness direction, the lobed walls are thus positioned between the flat outer envelope 31 and the flat inner envelope 32.

In the embodiment shown in FIG. 13, the frames 3 of the different tank walls are not fastened directly to one another. Indeed, the frames 3 are fastened together in this case by means of the lattice structure, instead of being fastened to one another via the perimeters thereof. The frames 3 arranged in a normal plane corresponding to the first direction are welded at the perimeters 4 thereof and the longitudinal stiffening members 5 thereof to first end bars 111. The frames 3 arranged in a normal plane corresponding to the second direction are welded at the perimeters 4 thereof and the longitudinal stiffening members 5 thereof to second end bars 121. The frames 3 arranged in a normal plane corresponding to the third direction are welded at the perimeters 4 thereof and the longitudinal stiffening members 5 thereof to the ends of third stiffening members 13.

The perimeters 4 of adjacent frames 3 are thus spaced apart by the minimum distance between the first end of a first end bar 111 and the first end of a second end bar 121 for example. In order to form a closed sealed surface about the entire tank, lobed corner walls 30 are welded to the perimeters 4 of adjacent frames 3 in order to fill the space between these frames 3. Each lobed corner wall 30 has a curved plate with two straight edges and four curved edges. The straight edges of the lobed corner walls 30 are welded to the perimeters 4 of two adjacent frames 3 of the outer structure 2. The curved edges are in turn welded to the curved edges of the adjacent lobed corner walls 30.

FIG. 15 shows a portion of the lattice structure for the self-supporting sealed tank of the third embodiment illustrated in FIG. 13. This lattice structure is formed somewhat similarly to the structure shown in FIG. 11, but differs therefrom as a result of the presence of lobed corner walls 30 and the gap between two adjacent frames 3. For this reason, only one corner of the lattice structure is shown in FIG. 15. Indeed, as a result of the modification of the outer structure 2, only the arrangement of the reinforcing stiffening members 29 has been modified in relation to the variant illustrated in FIG. 11. In the variant illustrated in FIG. 15, the reinforcing stiffening members 29 extend beneath the lobed corner walls 30 and are fastened on one side of one end of one of the internal stiffening members welded to the perimeter 4 of the frame 3 and on the other side to an end of one of the internal stiffening members welded to the perimeter 4 of an adjacent frame 3.

FIGS. 17 to 19 show a lattice structure of a self-supporting sealed tank formed by internal stiffening members according to a third variant. This variant differs from the previously illustrated variants notably on account of the assembly of the internal stiffening members with one another.

FIG. 17 shows a portion of the tank including the lattice structure. As previously, this structure has first stiffening members 11, second stiffening members 12, third stiffening members 13, complementary stiffening members 14 and reinforcing stiffening members 29.

The first stiffening members 11 and the second stiffening members 12 are formed as in the second variant by first end bars 111, first intermediate bars 112, second end bars 121 and second intermediate bars 122. Unlike the second variant, each third stiffening member 13 has a plurality of third bars 131, 132, the third bars 131, 132 being aligned with one another in the third direction and being spaced apart from one another. The third bars include two third end bars 131 positioned at the ends of the third stiffening member 13 and a plurality of third intermediate bars 132 positioned between the third end bars 131. The complementary stiffening members 14 are also formed by a plurality of complementary bars 141.

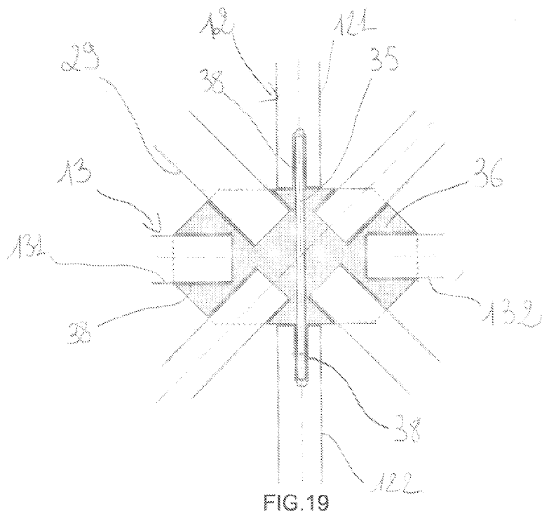

The lattice structure also includes dual connectors 33 and single connectors 34. The dual connectors 33 are formed by a first connection plate 35 and a second connection plate 36 that is orthogonal to the first connection plate 35. The first connection plate 35 has a fitting orifice 37 enabling the second connection plate to pass through the first connection plate in order to fasten said plates together to form the dual connector 33, as shown in FIG. 19 in combination with FIG. 17. The single connectors 34 are formed by a single connection plate 35. The connection plate 35 of the single connector 34 is fastened to one of the frames of the tank, either one of the longitudinal stiffening members or the perimeter of the frame.

The first end bars 111, the second end bars 121 and the third end bars 131 are welded at one end thereof to one of the single connectors 34 and at the other end thereof to one of the dual connectors 33. The first intermediate bars 112, the second intermediate bars 122 and the third intermediate bars 132 are welded at each of the ends thereof to one of the dual connectors 33.

Two adjacent first bars 111, 112 and two adjacent second bars 121, 122 are welded to the first connection plate 35 of one of the dual connectors 33, and two adjacent third bars 131 are welded to the second connection plate 36 of said dual connector 33. The dual connectors 33 thus form intersection zones of internal stiffening members 11, 12, 13 referred to as stiffening-member nodes 28.

The lattice structure also includes reinforcing stiffening members 29 formed by reinforcing bars 291. The reinforcing bars 291 are inclined at an angle of approximately 45° in relation to the first direction, to the second direction or to the third direction. The reinforcing bars 291 are fastened at one end thereof to a dual connector 33 and at the other end thereof to another dual connector 33 or to a single connector 34, as shown in FIGS. 17 and 19. Some dual connectors 33 are therefore welded to eight reinforcing bars 291, two first bars 111, 112, two second bars 121, 122 and two third bars 131, 132, while other dual connectors are only welded to two first bars 111, 112, two second bars 121, 122 and two third bars 131, 132.

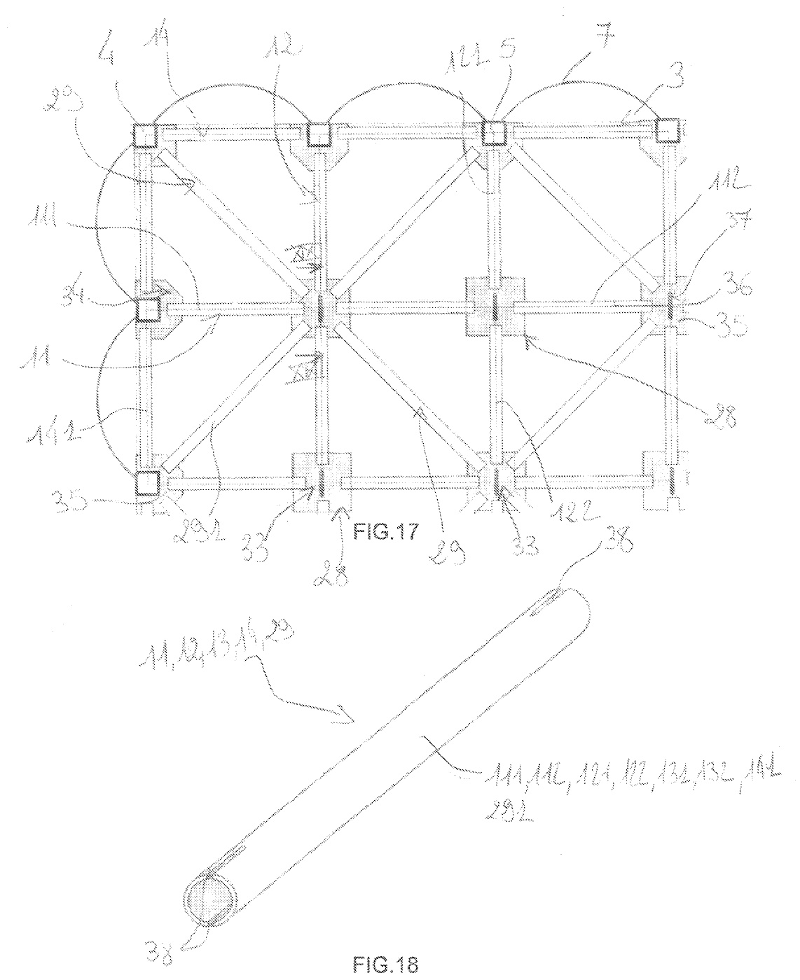

As shown in FIG. 18, all of the internal stiffening members 11, 12, 13, the reinforcing stiffening members 29 and the complementary stiffening members 14 are formed by bars 111, 112, 121, 122, 131, 132, 141, 291 of circular section. Each end of the bars 111, 112, 121, 122, 131, 132, 141, 291 of circular section has a pair of diametrically opposed fastening slots 38. These bars 111, 112, 121, 122, 131, 132, 141, 291 are therefore welded to a connector 33, 34 by inserting one of the connection plates 35, 36 into the pair of fastening slots 38.

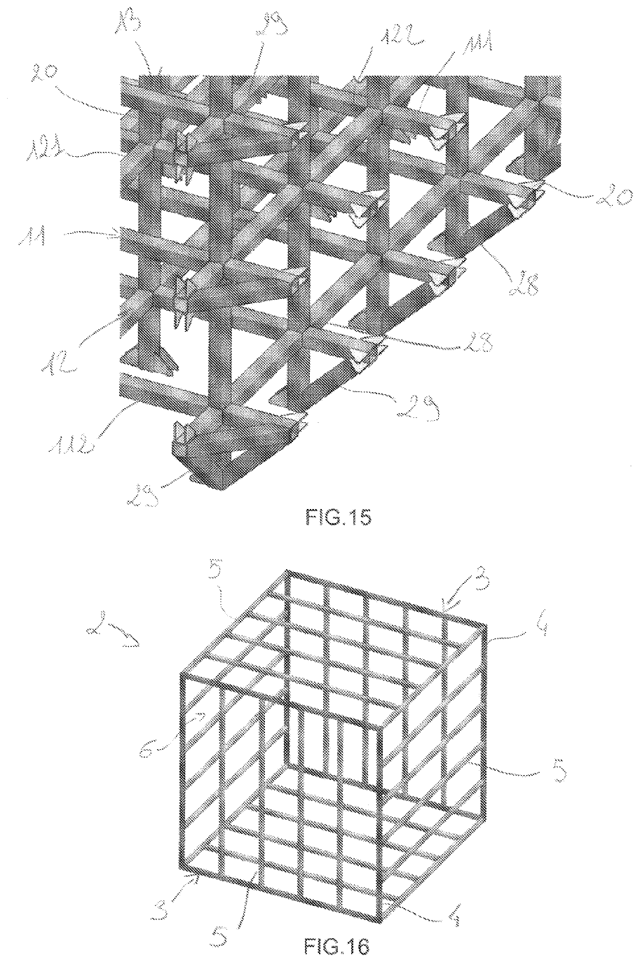

FIG. 16 is a perspective view of an outer structure 2 showing only the frames 3 according to another embodiment. In this embodiment, the outer structure 2 is formed only by two frames 3 forming two opposing walls of the tank 1. The frames 3 are in this case fastened to one another at the respective perimeter 4 thereof by means of longitudinal stiffening members 5. Furthermore, the longitudinal stiffening members 5 are also fastened to one another such as to form openings 6 on the other walls of the outer structure 2, which are identical to the openings 6 in the frames 3.

In this other embodiment, the manufacturing method of the sealed tank is slightly different from the embodiments disclosed previously. Indeed, since the outer structure 2 comprises just two frames 3, one of the frames 3 is first assembled and fitted with lobed walls such as to form a bottom wall of the tank. The internal stiffening members are assembled with one another such as to form the lattice structure. Finally, the other frame 3 is assembled with the frame 3 to form the bottom wall of the tank using longitudinal stiffening members.

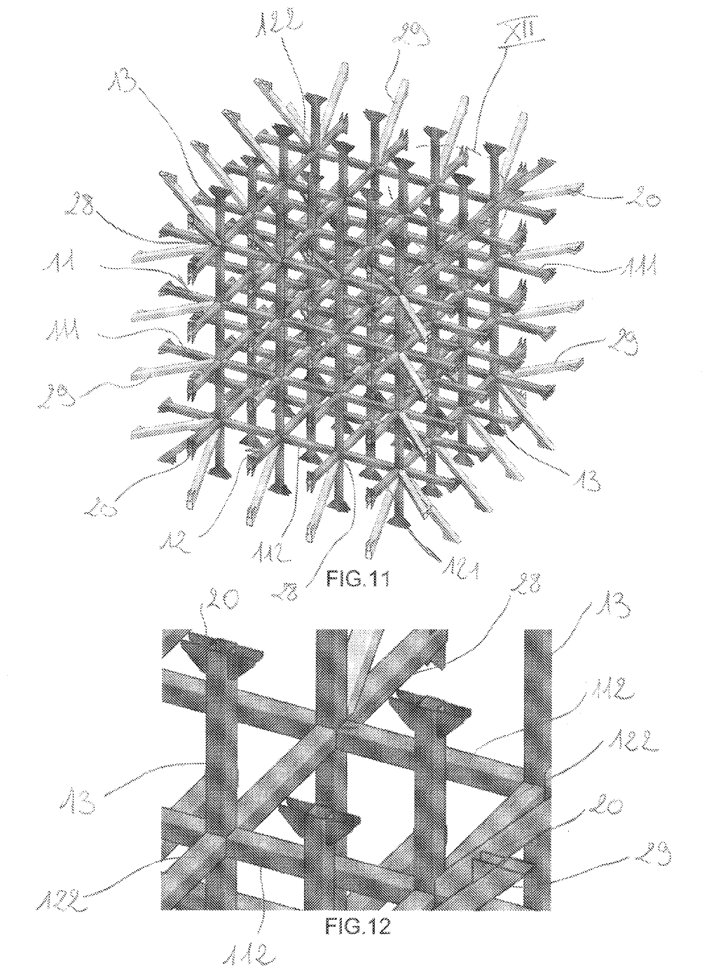

With reference to FIG. 10, a cut-away view of a liquefied natural gas carrier ship 70 shows a sealed and insulated tank 71 having an overall prismatic shape mounted in the double hull 72 of the ship. The wall of the tank 71 has a primary sealed barrier designed to be in contact with the LNG contained in the tank, a secondary sealed barrier arranged between the first sealed barrier and the double hull 72 of the ship, and two insulated barriers arranged respectively between the first sealed barrier and the second sealed barrier, and between the second sealed barrier and the double hull 72.

In a known manner, the loading/offloading pipes 73 arranged on the upper deck of the ship can be connected, using appropriate connectors, to a sea or port terminal to transfer a cargo of LNG to or from the tank 71.

FIG. 10 shows an example sea terminal comprising a loading/offloading point 75, an undersea line 76 and an onshore facility 77 The loading/offloading point 75 is a static offshore installation comprising a moveable arm 74 and a column 78 holding the moveable arm 74. The moveable arm 74 carries a bundle of insulated hoses 79 that can connect to the loading/offloading pipes 73. The orientable moveable arm 74 can be adapted to all sizes of liquefied natural gas carrier ships. A connecting line (not shown) extends inside the column 78. The loading/offloading point 75 makes loading and offloading of the liquefied natural gas carrier ship 70 possible to or from the onshore facility 77. This facility has liquefied gas storage tanks 80 and connection lines 81 connected via the undersea line 76 to the loading/offloading point 75. The undersea line 76 enables liquefied gas to be transferred between the loading/offloading point 75 and the onshore facility 77 over a large distance, for example 5 km, which makes it possible to keep the liquefied natural gas carrier ship 70 a long way away from the coast during loading and offloading operations.

To create the pressure required to transfer the liquefied gas, pumps carried on board the ship 70 and/or pumps installed at the onshore facility 77 and/or pumps installed at the loading/offloading point 75 are used.

Although the invention has been described in relation to several specific embodiments, it is evidently in no way limited thereto and it includes all of the technical equivalents of the means described and the combinations thereof where these fall within the scope of the invention.

Use of the verb “comprise” or “include”, including when conjugated, does not exclude the presence of other elements or other steps in addition to those mentioned in a claim.

In the claims, reference signs between parentheses should not be understood to constitute a limitation to the claim.

1. A sealed tank wall used to form a sealed tank for storing a fluid, the wall comprising:
a flat frame including a perimeter and longitudinal stiffening members arranged inside the perimeter in a longitudinal direction such that each longitudinal stiffening member extends from one side of the perimeter to an opposite side of the perimeter, the perimeter and the longitudinal stiffening members being designed to form openings in the frame,
lobed walls fastened to the frame by welding about said openings to close said openings, such as to project into a thickness direction orthogonal to the frame and towards the outside of the tank to be formed.

2. The tank wall as claimed in claim 1, in which the perimeter has a rectangular shape and comprises a plurality of bars assembled together.

3. The tank wall as claimed in claim 1, in which the frame has complementary stiffening members, the complementary stiffening members having a first end fastened to one side of the perimeter and a second end fastened to an opposite side of the perimeter and complementary stiffening members extending in a transverse direction perpendicular to the longitudinal direction of the longitudinal stiffening members.

4. The tank wall as claimed in claim 1, in which the wall has a thermally insulating barrier fastened to the frame on the outside of the tank to be formed.

5. The tank wall as claimed in claim 4, in which the thermally insulating barrier has an inner surface shaped to match the lobed walls.

6. The tank wall as claimed in claim 4, in which the thermally insulating barrier has an inner layer made of a flexible deformable insulating material and an outer layer made of a rigid insulating material.

7. The tank wall as claimed in claim 1, in which the lobed walls have curved plates with at least two curved sides, and closing plates positioned on the curved sides of the curved plates, the closing plates sealingly linking the curved sides to the frame.

8. The tank wall as claimed in claim 7, in which the curved plates are rectangular curved plates with two curved sides and two straight sides, the straight sides being welded to the frame on either side of an opening.

9. A sealed tank for storing fluid, the tank comprising:
an outer structure comprising a plurality of tank walls assembled together to form a prismatic structure delimiting an internal space, at least two of the tank walls being as claimed in claim 1; and
internal stiffening members positioned in the internal space of the outer structure to form a lattice structure, each internal stiffening member having a first end fastened to the frame of a first of the at least two tank walls and a second end fastened to the frame of a second of the at least two tank walls opposite the first tank wall, the internal stiffening members being fastened to said frames to absorb a force caused by the pressure in said internal space.

10. The sealed tank as claimed in claim 9, in which an internal stiffening member is positioned level with a longitudinal stiffening member of said frame and extends perpendicular to said tank wall.

11. The sealed tank as claimed in claim 9, in which each of the tank walls is as claimed in claim 1.

12. The sealed tank as claimed in claim 9, in which the internal stiffening members include first stiffening members oriented in a first direction, second stiffening members oriented in a second direction different from the first direction, and third stiffening members oriented in a third direction different from the first direction and from the second direction.

13. The sealed tank as claimed in claim 12, in which the first direction, the second direction and the third direction form a three-dimensional orthogonal frame.

14. The sealed tank as claimed in claim 12, in which the internal stiffening members are made of bars of square section.

15. The sealed tank as claimed in claim 12, in which one of the first stiffening members has at least one orifice that is designed to enable one of the third stiffening members to pass through the first stiffening member.

16. The sealed tank as claimed in claim 12, in which one of the second stiffening members has at least one orifice that is designed to enable one of the third stiffening members to pass through the second stiffening member.

17. The sealed tank as claimed in claim 9, in which each internal stiffening member has at least one elongate sheet and at least one profile including a base fastened to the elongate sheet and two flanges on either side of the base, the flanges projecting from the elongate sheet.

18. The sealed tank as claimed in claim 12, in which one of the first stiffening members and/or one of the second stiffening members has two elongate sheets and a plurality of profiles positioned between the two elongate sheets, the profiles including a base fastened to one of the elongate sheets and two flanges on either side of the base, the flanges projecting from each elongate sheet, and in which the profiles are spaced apart regularly on the elongate sheet.

19. The sealed tank as claimed in claim 14, in which the orifice that is designed to enable one of the third stiffening members to pass through one of the first stiffening members or one of the second stiffening members is a space formed between the profiles.

20. The sealed tank as claimed in claim 12, in which each third stiffening member comprises a single elongate stiffening member extending from one tank wall to an opposite tank wall.

21. The sealed tank as claimed in claim 12, in which each third stiffening member has a plurality of third bars, the third bars being aligned with one another in the third direction and being spaced apart from one another.

22. The sealed tank as claimed in claim 20, in which each first stiffening member and/or each second stiffening member has a plurality of first bars and/or second bars respectively, the first bars or the second bars being aligned with one another in the first direction or the second direction respectively, the first bars or the second bars being spaced apart from one another.

23. The sealed tank as claimed in claim 22, in which the first bars include two first end bars positioned at the ends of the first stiffening member and at least one first intermediate bar positioned between the first end bars, two adjacent first bars being fastened to one another by means of one of the third stiffening members.

24. The sealed tank as claimed in claim 22, in which the second bars include two second end bars positioned at the ends of the second stiffening member and at least one second intermediate bar positioned between the second end bars, two adjacent second bars being fastened to one another by means of one of the third stiffening members.

25. The sealed tank as claimed in claim 21, in which the tank has connectors formed by at least one connection plate, two first adjacent bars, two second adjacent bars or two third adjacent bars being fastened to one another by means of one of the connectors.

26. The sealed tank as claimed in claim 25, in which the internal stiffening members and the connectors are designed to be assembled together with at least two degrees of freedom.

27. The sealed tank as claimed in claim 25, in which the first bars, the second bars and the third bars have a pair of parallel fastening slots at each of the ends thereof, and the first bars, the second bars and the third bars are designed to be welded to one of the connection plates by inserting said connection plate into the pair of fastening slots.

28. The sealed tank as claimed in claim 24, in which the first end bars or the second end bars have a first end fastened to the outer structure and a second end fastened to one of the third stiffening members.

29. The sealed tank as claimed in claim 9 one of claims 9 to 28, in which the lattice structure has stiffening-member nodes, each stiffening-member node being designed to form an intersection zone in the lattice structure where at least two internal stiffening members cross.

30. The sealed tank as claimed in claim 29, in which the tank has reinforcing stiffening members inclined at an angle of approximately 45° in relation to the first direction, to the second direction or to the third direction, the reinforcing stiffening members being fastened at one of the ends thereof to one of the stiffening-member nodes and at the other of the ends thereof to another of the stiffening-member nodes or one of the tank walls.

31. The sealed tank as claimed in claim 9, in which a first of said tank walls is fastened to a second of said tank walls by welding the frame of the first tank wall to the frame of the second tank wall.

32. The sealed tank as claimed in claim 9, in which a first of said tank walls is fastened to a second of said tank walls by means of a lobed corner wall, the lobed corner wall having a first straight edge fastened to the perimeter of the first tank wall and a second straight edge fastened to the perimeter of the second tank wall.

33. A ship used to transport a cold liquid product, the ship having a double hull and a tank as claimed in claim 9 placed inside the double hull.

34. The ship as claimed in claim 33, in which the sealed tank is fastened to the double hull using cables.

35. The ship as claimed in claim 34, in which the sealed tank has a center and edges at the join between the frames, the cables being fastened at the edges of the tank and being fastened to the double hull such as to be oriented orthogonally to the direction linking the center of the tank to the edge where the cable is fastened.

36. A transfer system for a cold liquid product, the system including a ship as claimed in claim 33, insulated pipes arranged to connect the tank installed in the hull of the ship to an onshore or floating storage facility and a pump for driving a flow of cold liquid product through the insulated pipes to or from the onshore or floating storage facility to or from the tank on the ship.

37. A manufacturing method for a prismatic sealed tank, in which the method includes the following steps:
providing several tank walls as claimed in claim 1,
assembling the tank walls together sealingly to form an open prismatic outer structure,
providing a plurality of internal stiffening members,
fastening the internal stiffening members to the inside of the outer structure such as to form a lattice structure, each internal stiffening member having a first end fastened to a frame and a second end fastened to an opposing frame, the internal stiffening members being fastened to the longitudinal stiffening members or to the perimeters of said frames, and
assembling one or more tank walls to the open outer structure such as to sealingly close the prismatic outer structure.

38. A manufacturing method for a prismatic sealed tank, in which the method includes the following steps:
providing several tank walls as claimed in claim 1,
arranging one of the tank walls such as to form a bottom wall of the tank,
providing a plurality of internal stiffening members,
fastening the internal stiffening members to the bottom wall of the tank and to one another such as to form a lattice structure, and
sealingly assembling the other tank walls to the bottom wall of the tank and to one another such as to form a closed prismatic outer structure, each internal stiffening member having a first end fastened to a frame and a second end fastened to an opposing frame, the internal stiffening members being fastened to the longitudinal stiffening members or to the perimeters of said frames.

39. A method for loading or offloading a ship as claimed in claim 33, in which a cold liquid product is channeled through insulated pipes to or from an onshore or floating storage facility to or from the tank on the ship.
